(19) United States
(12) Patent Application Publication
(10) Pub. No.: US 2009/0157817 A1
(43) Pub. Date: Jun. 18, 2009

(54) USING AN UNSYNCHRONIZED EVENT POOL TO IMPROVE PERFORMANCE OF AN EVENT DRIVEN IM GATEWAY

(75) Inventor: Victor L. Williamson, Woburn, MA (US)

Correspondence Address: PATENTS ON DEMAND, P.A. - IBM CAM, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/954,276

(22) Filed: Dec. 12, 2007

(51) Int. Cl. G06F 15/16

(52) U.S. Cl. 709/206

(57) ABSTRACT

The present invention discloses a solution for using an unsynchronized event pool in an IM gateway. In the solution, a set of object pools can be established, each including a set of event objects ordered relative to each other in a circular fashion. The IM gateway can detect an incoming message. A CPU processing thread for handling the incoming message can be determined. One of the unsynchronized event object pools associated with the thread can be ascertained. A current one of the ordered event objects within the pool can then be determined. The current one can be an object ordered after a last event object used from the pool. The thread can utilize the determined event object to handle a task for the incoming message, which negates a need and a time to create a new event object for the thread.

### BACKGROUND

1. Field of the Invention

The present invention relates to the field of event driven gateways and, more particularly, to using an unsynchronized event pool to improve performance of an event driven instant messaging (IM) gateway.

2. Description of the Related Art

Instant Messaging (IM) systems are text exchange communication systems for text exchange communications in near real-time. IM messages are often routed through IM gateways, which serve as a single point of contact. IM gateways can be used to handle a number of IM related issues, such as permitting IM communications across different networks, blocking IM viruses and other malware, filtering IM spam or spim, archiving session information, providing perimeter security, encrypting/decrypting messages, and the like. IM event gateways can also function as real-time information brokers that bypass HTML to permit communications via Short Messaging Server (SMS) or permitting communications with non-Web clients, such as a mobile phone. IM gateways have become an instrumental component of an IM infrastructure.

A current problem with many IM gateways, especially event driven ones, is they tend to halt under load, which results in a stagnation of status changes and IM messages. Poor IM gateway performance results mainly from one of two factors. The first is excessive use of a central processing unit (CPU). The second is excessive memory consumption. In an IM gateway context, two CPU intensive operations are object creation and tread contention operations.

At least two event objects are created for each status notification or IM message, which include an object for the initial event and one for a returned status event. During peak load times, an average IM gateway can be responsible for creating hundreds of event objects per second. To create an object, software must navigate an inheritance tree to determine an amount of memory that is to be allocated, must allocate the memory, must update a memory table, and must then initialize all fields by calling constructors for each class in the inheritance tree. While object creation costs can vary per implementation, a reasonable gauge for an average cost to create an object can be approximately seventeen milliseconds.

The second factor that consumes CPU cycles is that of thread contention. Method synchronization in an uncontested environment can add anywhere between ten to two hundred percent to method processing times, which is typically acceptable overhead. When threads contend, however, an OS must switch thread contexts. When thread contexts switch, a CPU cache is invalidated and flushed. Additionally, when multiple processors or processing cores are used, a thread queue must be synchronized across these cores. One or more processing cores can sit idle if threads in the thread queue are waiting for a specific monitor. A general cost estimate for a thread contention situation can be a cost equivalent to fifty object creation activities.

A number of techniques have been attempted to reduce CPU loads experienced by an IM gateway. One of these techniques is to use an event pool. An event pool establishes a pool of reusable objects, which means that new objects do not create nor destroy for each IM event, which reduces CPU load for creating objects. Object pools are conventionally maintained using synchronized structures. This means that in a highly threaded environment, use of a synchronized event pool greatly increases a risk of thread contention. Increased CPU costs due to thread contention generally offsets or overshadows potential gains obtained by reducing object creation events in an IM gateway context.

### SUMMARY OF THE INVENTION

The disclosed invention describes an enhancement for an event driven instant messaging (IM) gateway for using an unsynchronized event pool. The unsynchronized event pool can reduce object creation costs without significantly adding thread contention costs, as is the case with a synchronized thread pool. In other words, an unsynchronized event pool can be established to provide a pool of event objects for each thread, which may need event objects. When an IM gateway is initiated, an unsynchronized event pool can be created containing a statically allocated set of all the necessary objects for each event type. Once created, the event objects are ready for use, but are stored in an idle/available state.

In one embodiment, each thread can have an associated event pool of object types, which can be represented by a thread specific array, which can be of varying user specifiable lengths. An index counter for each thread and event type can be used so that each array has an associated counter. The counter can increment when an event object is requested, which results in an event object of the associated array having the counter's designated position being used. The counter can loop back to an array's beginning when the counter's value reaches the array's length. The size of each array in a standard implementation that handles one request per thread would be of length one as only a single event object is needed by the thread. However, this invention does not prohibit more complicated implementations where a single thread may handle multiple requests. In these cases the array length should safely double an expected number of concurrent events of each type in the IM gateway. This ensures that a counter specified event object has been “returned” to the event pool by the time it is next requested. For example, in a two thousand user deployment during peak load twenty five IM events per second can be expected, which would indicate that an associated array should have a length of fifty (twice twenty five). Historical usage information can be used to establish a proper size for each array of event objects.

Further, in one embodiment, usage of an array can be monitored so that if an array is of insufficient size to handle incoming requests, an adjustment can be made. For example, one or more additional “overflow” thread pools can be established to be used when an array is temporarily “overloaded.” If an event object array is often placed in an overloaded state, the size of that array (and corresponding event object pool) can be automatically increased.

The present invention can be implemented in accordance with numerous aspects consistent with the materials presented herein. One aspect of the present invention can include an IM gateway that includes a set of threads for handling IM events and a set of unsynchronized event object pools. A one-to-one correspondence can exist between the threads and the unsynchronized event object pools. Each of the unsynchronized event object pools can include a set of event objects utilized by the IM gateway when handling received requests.

Another aspect of the present invention can include a method for an event driven IM gateway to obtain event objects. During an initialization process, an IM gateway can create a set of event objects, where the event objects are associated with a set of unsynchronized event object pools. Within each unsynchronized event object pool, the event objects can be ordered relative to each other in a circular fashion. The IM gateway can detect an incoming message from a remotely located client for an IM status notification or for an IM. A CPU processing thread for handling the incoming message can be determined. One of the unsynchronized event object pools associated with the thread can be ascertained. A current one of the ordered event objects within the pool can then be determined. The current one can be an object ordered after a last event object used from the pool. The thread can utilize the determined event object to handle a task for the incoming message.

Still another aspect of the present invention can include a method for responding to events in an event driven IM gateway. The method can detect an IM event. An array associated with a set of event objects contained within an unsynchronized event pool can be identified for handling the IM event. Each array element can be associated with an event object included in the unsynchronized event pool. A current value of a counter associated with the array can be determined. One of the event objects specified within the array that has an array position matching the counter's value can be determined. The identified event object can be retrieved and used to handle the IM event. A value of the array counter can then be increased. When increasing the value of the counter would normally exceed a length of the associated array, the counter can be reset to a value representing a beginning of the array.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system of an event driven instant messaging (IM) gateway that uses a set of unsynchronized object pools to provide IM event objects as needed.

FIG. 2 is a schematic diagram of a system that shows a pool manager that uses an unsynchronized pool of event objects in accordance with an embodiment of the inventive arrangements disclosed herein.

FIG. 3 shows sample JAVA code for implementing an event pool class for use with an IM gateway in accordance with an embodiment of the inventive arrangements disclosed herein.

### DETAILED DESCRIPTION OF THE INVENTION

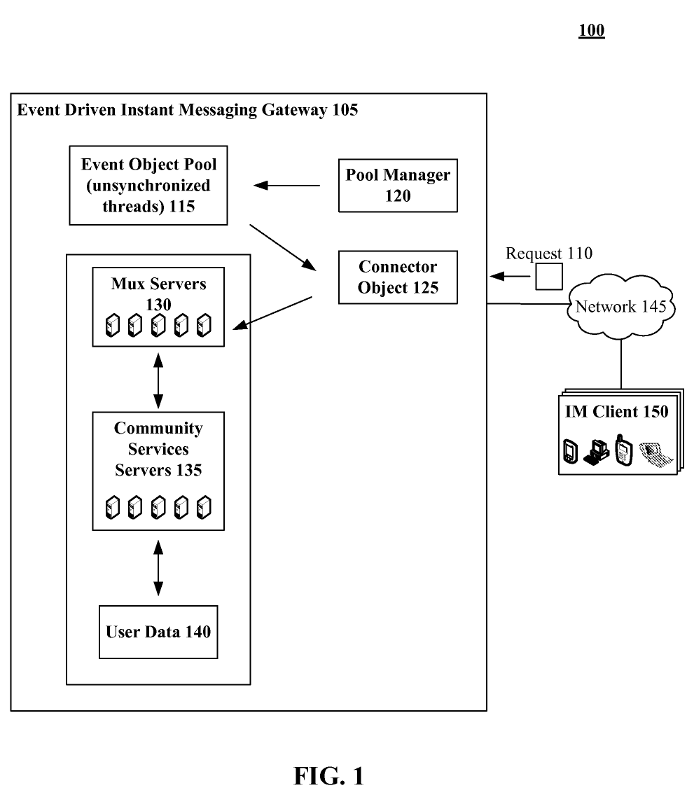

FIG. 1 is a schematic diagram of a system 100 of an event driven instant messaging (IM) gateway 105 that uses a set of unsynchronized object pools 115 to provide IM event objects as needed. A set of IM clients 150 can convey requests 110 over a network 145 to the gateway 105. For each request, the gateway 105 can select a thread from a queue to handle the request. The thread can be associated with an event object pool 115, which contains event objects that were created when the gateway 105 was established. IM event objects in the pool 115 can include initial event objects and status objects. The gateway 105 can be a stand-alone gateway or can represent a cluster of linked devices.

IM clients 150 can be any computing device capable of communicating and sending and/or receiving instant message communications. IM clients 150 can communicate with other IM clients 150. IM clients 150 can be any device including, but not limited to, a desktop computer, a laptop computer, a personal data assistant (PDA), a mobile phone, a laptop computer, and the like.

The network 145 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 145 can include local components and data pathways necessary for communications to be exchanged among computing device components and between integrated device components and peripheral devices. The network 145 can also include network equipment, such as routers, data lines, hubs, and intermediary servers which together form a packet-based network, such as the Internet or an intranet. The network 145 can further include circuit-based communication components and mobile communication components, such as telephony switches, modems, cellular communication towers, and the like. The network 145 can include line based and/or wireless communication pathways.

Connector object 125 can be an optional data object used to connect an acquired object from event object pool 115 to a mux server 130 or other server handling request 110. Connector object 125 can be an object usable by any of the types of objects stored in event object pool 115. Connector object 125 can allow the communication between an acquired object from event object pool 115. In some embodiments, connector object 125 can also allow the communication between an acquired object and community services servers 135.

Mux servers 130 can be servers used to manage end-user connections to the event driven instant messaging gateway 105. Mux servers 130 can include any number of servers required to manage the load of event driven instant messaging gateway 105. Mux servers 130 can be accessed in a load balanced fashion, such as round-robin load balancing. In round-robin load balancing, each server is given the next connection sequentially, so a single server isn't burdened with more incoming connections than it can handle. Mux servers 130 can be implemented in any way in which servers are setup to manage end-user connections to event driven instant messaging gateway 105.

Community services servers 135 can handle the presence and messaging traffic for event driven instant messaging gateway 105. Presence traffic can include traffic dedicated to maintaining the status of a user. For example, a presence request can alert event driven instant messaging gateway 105 of the status of a user, or can be used to retrieve the status of other users. Such status can include, but is not limited to, online, offline, away, not available, or the like. Messaging traffic can include traffic dedicating to the transmission of instant messaging. For example, a message can include a text communication from a user meant for event driven instant messaging gateway 105 to convey to another user.

User data 140 can be maintained or accessible by gateway 105, which can include data stored for each user that can connect to event driven instant messaging gateway 105. The data stored for each user can include, but is not limited to, the user's full name, the user's handle they use online, email address, age, sex, a users connectivity status, and the like.

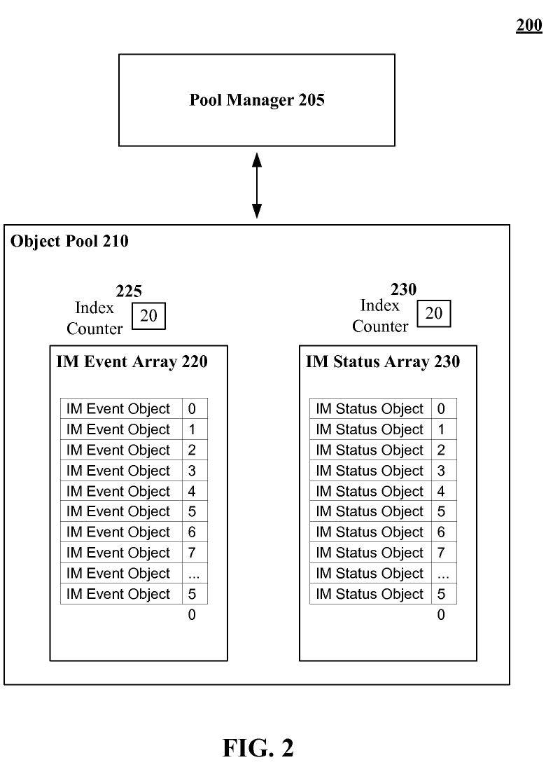

FIG. 2 is a schematic diagram of a system 200 that shows a pool manager 205 that uses an unsynchronized pool 210 of event objects in accordance with an embodiment of the inventive arrangements disclosed herein. The pool manager 205 can be a software engine used to manage an object pool 210 in an event driven IM gateway. The system 200 shows details for possible interactions between pool manager 120 and pool 115 of FIG. 1.

In system 200, pool manager 205 can manage object pool 210. Object pool 210 can include IM event array 220 and IM status array 230. Each type of array 220, 230 can be associated with a specific thread, which is used for IM event management purposes. When multiple threads are used, additional arrays 220, 230 and event object pools 210 can be established. Index counter 225 can contain the current index of IM event array 220 and index counter 230 can contain the current index of IM status array 230. In one embodiment, IM event array 220 and IM status array 230 can be stored as an associative array, where an associative array is a map in which an element acts as a key related to a value. For example, a key at a certain index in IM event array 220 can be associated with a value at the same index in IM status array 230. In another embodiment, IM event array 220 and IM status array 230 can be a single multi-dimensional array, combining IM event array 220 and IM status array 230.

When the pool 210 is initiated, the IM event objects and IM status objects associated with arrays 220 and 230 can be created. A size of each array 220, 230 can be twice that of expected maximum usage in order to ensure that sufficient event objects and status objects exist for a given thread. For example, as shown, fifty event objects and status objects exist per array 220, 230, which indicates that an expected maximum usage for each associated thread is twenty five objects.

The pool manager 205 can receive requests for an event driven instant messaging gateway. A thread queue can be used to handle each received request. A thread from the pool 210 can grab an event object and/or a status object from the pool 210 as needed to handle the request. The index counter 225 or 230 indicates which pool 210 object is to be used by the thread. Each time a thread utilizes an object, an associated counter 225, 230 can be increased by one. When the counter 225, 230 is at a maximum array length (e.g., 50) when an increment is indicated, the counter 225, 230 can be reset to zero.

It should be appreciated that use of counters 225, 230 and arrays 220, 230 is one means for sequentially ordering event objects in a circular fashion. Other means can be utilized and are to be considered within the scope of the present invention.

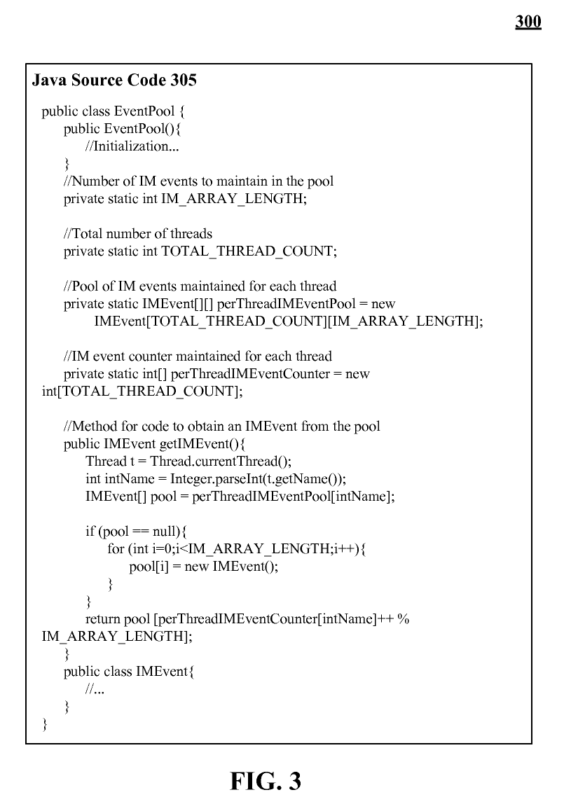

FIG. 3 shows sample JAVA code 305 for implementing an event pool class for use with an IM gateway in accordance with an embodiment of the inventive arrangements disclosed herein. Code 305 can be used in the context of system 100 or system 200. The code 305 is presented for illustrative purposes the invention is not to be construed as limited in this regard. For example, although JAVA is a reasonable language choice for coding an IM gateway event pool, other languages, such as C, C++, and the like can be used.

As shown in code 305, an array is established that is associated with a thread specific event object pool. For each array a unique integer is established as a counter, starting from zero to a maximum length of the thread, which thereafter loops back to zero. A variable, TOTAL_THREAD_COUNT, in code 305 identifies a total number of threads in the configured thread pool. Appreciably, code 305 shows a skeletal implementation class EventPool and includes only a single event object. Actual implementations would include pools and counters for each event type and for each thread that is used for events in the IM gateway.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. An instant messaging (IM) gateway comprising:
a plurality of threads for handing IM events; and
a plurality of unsynchronized event object pools, wherein a one-to-one correspondence exists between the threads and the unsynchronized event object pools, wherein each unsynchronized event object pools comprises a set of event objects utilized by the IM gateway when handling received requests.

2. The gateway of claim 1, wherein said IM gateway creates the set of event objects contained in each of the unsynchronized event object pools when initiated, wherein the created set of event objects are maintained while the IM gateway operates so that available ones of the set of event objects are used to handle received requests so that the IM gateway does not need to create new event objects for each received request.

3. The gateway of claim 1, further comprising:
at least one array of event objects corresponding to each of the unsynchronized event object pools, wherein an array element exists for each of the set of event objects in the associated unsynchronized event pool; and
a counter associated with the array of event objects, wherein a value of the counter is matched against the event object of the array position having a value the same as the counter to determine which of the event objects is to be selected from the unsynchronized event object pool, wherein said counter is incremented after being utilized to reference a next event object in event pool, and wherein when incrementing the counter would cause the counter to exceed an array length of the associated array, the counter is reset to a value indicating a first position of the associated array.

4. The gateway of claim 3, wherein the at least one array associated with each of the unsynchronized event object pools comprises an IM event array and an IM status array, each having an array specific counter.

5. The gateway of claim 4, wherein a number of event objects included in each of the unsynchronized event object pools is user configurable.

6. The gateway of claim 4, wherein different ones of the unsynchronized event object pools include a different number of event objects.

7. A method for an event driven IM gateway to obtain event objects comprising:
during an initialization process, an IM gateway creating a set of event objects, said event objects being associated with a plurality of unsynchronized event object pools;
within each unsynchronized event object pool, ordering the event objects relative to each other in a circular fashion;
the IM gateway detecting an incoming message from a remotely located client for at least one of an IM status notification and an IM;
determining a CPU processing thread for handling the incoming message;
ascertaining one of the unsynchronized event object pools associated with the thread;
determining a current one of the ordered event objects, where the current one is an object ordered after a last event object used from the ascertained pool; and
the thread utilizing the determined event object to handle a task for the incoming message.

8. The method of claim 7, wherein a number of event objects contained in each of the unsynchronized event object pools is user configurable.

9. The method of claim 7, wherein each unsynchronized event object pool comprises a set of IM event objects and a set of IM status objects, wherein said ordering step orders each of the event object relative to each other in a circular fashion by object type, wherein said determining step determines one of the IM event objects and one of the IM status objects, and wherein the utilizing step utilizes both the IM event object and the IM status object.

10. The method of claim 7, further comprising:
establishing an array for each of the unsynchronized event object pools and a counter, wherein a number of items of the array equals the number of event objects contained in the associated pool; one event object being associated with one array item, wherein the determining step matches a current value of the counter with a current position in the array to determine the current one of the ordered event items; and
after the determining step, increasing a value of the counter, wherein when increasing the value of the counter would normally exceed a length of the associated array, the counter is reset to a value representing a beginning of the array.

11. The method of claim 7, wherein a one-to-one correspondence exists for the threads used by the IM gateway and the unsynchronized event object pools.

12. The method of claim 7, wherein said steps of claim 7 are performed by at least one machine in accordance with at least one computer program stored in a computer readable media, said computer programming having a plurality of code sections that are executable by the at least one machine.

13. A method for events in an event driven Instant Messaging (IM) gateway comprising:
detecting an IM event, which requires an IM gateway to utilize an even object;
obtaining an event object for the IM event from an unsynchronized event pool; and
utilizing the obtained event object when responding to the IM event.

14. The method of claim 13, wherein said IM event is at least one of an initial event and a returned status event.

15. The method of claim 13, further comprising:
determining a next tread in a thread queue for handling the detected IM event;
identifying an unsynchronized event pool specific to the determined thread; and
obtaining the event object from the identified unsynchronized event pool, wherein each thread in the thread queue is associated with a different unsynchronized event pool containing a plurality of event objects.

16. The method of claim 13, further comprising:
identifying an array associated with a plurality of event objects contained within the unsynchronized event pool, wherein each array element is associated with an event object included in the unsynchronized event pool;
determining a current value of a counter associated with the array;
determining one of the plurality of event objects specified within the array that has a value in the array of the current value;
wherein the event object of the obtaining step is the determined one of the event objects; and
increasing a value of the counter, wherein when increasing the value of the counter would normally exceed a length of the associated array, the counter is reset to a value representing a beginning of the array.

17. The method of claim 16, wherein the IM event is one of an initial event and a returned status event, wherein the array is one of a event array associated with IM event objects and a status array associated with IM status objects; said method further comprising:
determining whether the IM event is for the initial event or for the returned status event; and
utilizing a corresponding one of the event array and the status array based upon the determined type of IM event, wherein the event object of the obtaining and utilizing step is of an appropriate type for the determined type of IM event.

18. The method of claim 16, further comprising:
determining a next tread in a thread queue for handling the detected IM event;
identifying an unsynchronized event pool specific to the determined thread; and
obtaining the event object from the identified unsynchronized event pool, wherein each thread in the thread queue is associated with a different unsynchronized event pool containing a plurality of event objects.

19. The method of claim 13, wherein said steps of claim 13 are performed by at least one machine in accordance with at least one computer program stored in a computer readable media, said computer programming having a plurality of code sections that are executable by the at least one machine.
